(19) United States
(12) Patent Application Publication
(10) Pub. No.: US 2016/0210914 A1
(43) Pub. Date: Jul. 21, 2016

(54) METHOD FOR TRANSMITTING DATA FROM TIMING CONTROLLER TO SOURCE DRIVER AND ASSOCIATED TIMING CONTROLLER AND DISPLAY SYSTEM

(71) Applicant: HIMAX TECHNOLOGIES LIMITED, Tainan City (TW)

(72) Inventors: Peng-Chi Chen, Tainan City (TW); Chan-Fei Lin, Tainan City (TW); Yung-Chin Hsiao, Tainan City (TW); Jung-Cheng Hung, Tainan City (TW)

(21) Appl. No.: 14/599,557

(22) Filed: Jan. 19, 2015

(51) Int. Cl. G09G 3/36

(52) U.S. Cl. CPC G09G 3/3611; G09G 2300/0478; G09G 2300/08; G09G 2330/06

(57) ABSTRACT

A method for transmitting data from a timing controller to a source driver includes: applying a plurality of data rates to a discrete data rate setting; and transmitting image data of a plurality of frames by using the plurality of data rates, respectively, wherein for each of the frames, its corresponding image data is transmitting by using only one of the data rates.

### BACKGROUND OF THE INVENTION

1. Field of the Invention

The present invention relates to display system, and more particularly, to a method for transmitting data from a timing controller to a source driver and associated timing controller and display system.

2. Description of the Prior Art

In a conventional point-to-point (P2P) timing controller, frame data is transmitted to a plurality of source drivers by using a single data rate. However, using a single data rate to transmit will cause a high electromagnetic interference (EMI) peak. In addition, because the P2P timing controller uses a Serializer/Deserializer (SerDes) interface to transmit the frame data, and the data rate is very high (e.g. more than 1 Gb/s), therefore, the conventional spread spectrum techniques are difficult to be applied to the P2P timing controller.

### SUMMARY OF THE INVENTION

It is therefore an objective of the present invention to provide a method for transmitting data from a timing controller to a source driver and associated timing controller and display system, which uses different data rates to transmit frame data to effectively reduce the EMI peak, to solve the above-mentioned problems.

According to one embodiment of the present invention, a method for transmitting data from a timing controller to a source driver comprises: applying a plurality of data rates to a discrete data rate setting; and transmitting image data of a plurality of frames by using the plurality of data rates, respectively, wherein for each of the frames, its corresponding image data is transmitting by using only one of the data rates.

According to another embodiment of the present invention, a timing controller of a display is disclosed. The timing controller is arranged for applying a plurality of data rates to a discrete data rate setting, and transmitting image data of a plurality of frames by using the plurality of data rates, respectively, wherein for each of the frames, its corresponding image data is transmitting by using only one of the data rates.

According to another embodiment of the present invention, a display system comprises a timing controller and at least one source driver, where the timing controller is arranged for applying a plurality of data rates to a discrete data rate setting, and transmitting image data of a plurality of frames by using the plurality of data rates, respectively, to the source driver; and for each of the frames, its corresponding image data is transmitting by using only one of the data rates.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a display system according to one embodiment of the present invention.

FIG. 2, which is diagram showing transmitting frames by using data rates according to one embodiment of the present invention.

FIG. 3 is a diagram illustrating a format of a frame according to one embodiment of the present invention.

FIG. 4 is a flowchart of a method for transmitting data from a timing controller to a source driver according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

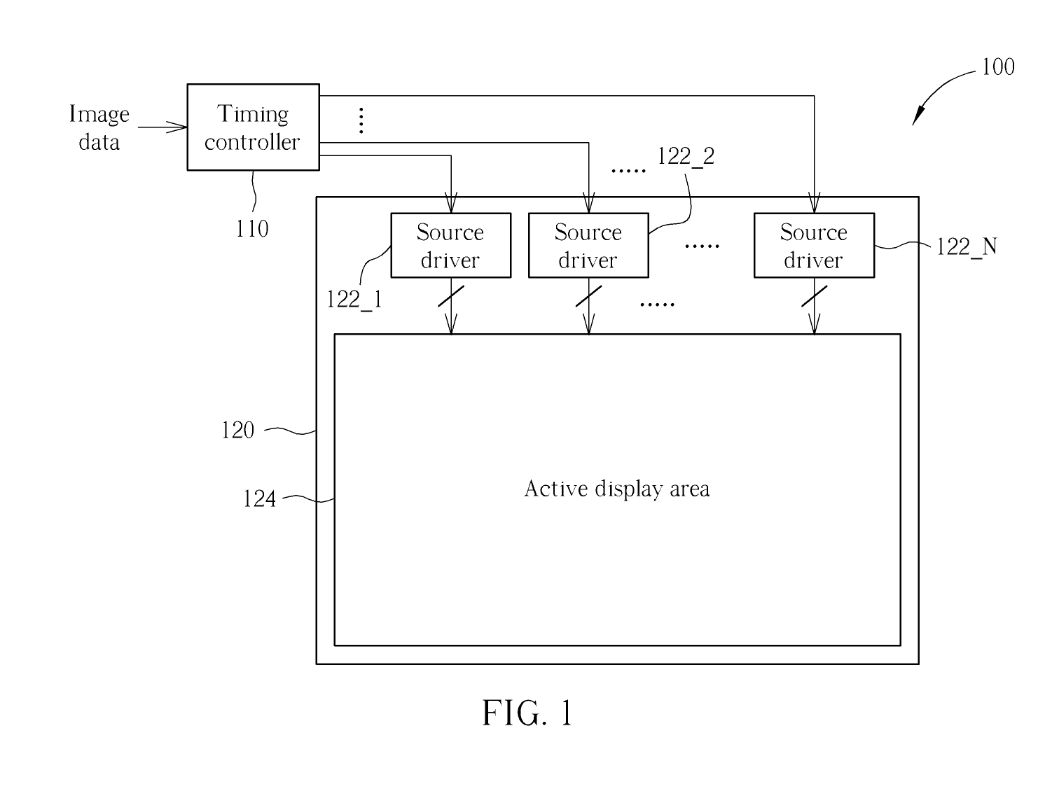

Please refer to FIG. 1, which is a diagram illustrating a display system 100 according to one embodiment of the present invention. As shown in FIG. 1, the display system 100 comprises a timing controller 110 and a display panel 120, where the display panel 120 comprises at least one source driver (in this embodiment there are a plurality of source drivers 122_1-122_N) and an active display area 124 (the active display area 124 is also named as an active array). In this embodiment, the timing controller 110 is a P2P timing controller, and the timing controller 110 uses a Serializer/Deserializer (SerDes) interface to transmit frame data to the source drivers 122_1-122_N, respectively, and the display system 100 is a liquid crystal display (LCD).

In the operations of the display system 100, first, the timing controller 110 applies a plurality of data rates to a discrete data rate setting. Then, the timing controller 110 sequentially receives image data of a plurality of frames, and transmits the (processed) image data of the plurality of frames to each of the source drivers 122_1-122_N by using the plurality of data rates, respectively, where for each of the frames, its corresponding image data is transmitting by using only one of the data rates. Then, after receiving the image data from the timing controller 110, the source drivers 122_1-122_N transmits corresponding data to data lines of the active display area 124.

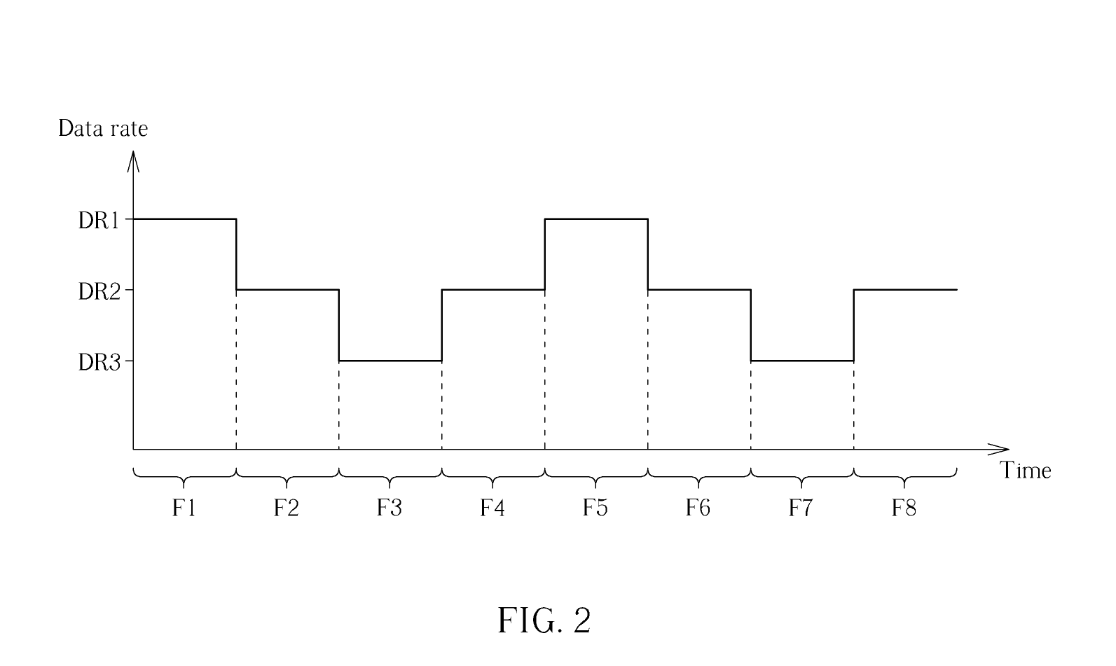

In detail, referring to FIG. 2, which is diagram showing transmitting frames by using data rates DR1-DR3 according to one embodiment of the present invention. Referring to FIG. 2, the timing controller 110 uses the data rate DR1 to transmit image data of the first frame F1 to the source drivers 122_1-122_N, uses the data rate DR2 to transmit image data of the second frame F2 to the source drivers 122_1-122_N, uses the data rate DR3 to transmit image data of the third frame F3 to the source drivers 122_1-122_N, uses the data rate DR2 to transmit image data of the fourth frame F4 to the source drivers 122_1-122_N, and repeatedly uses the data rates DR1, DR2, DR3, DR2 to transmit the following frames F5, F6, F7, F8, respectively, . . . . By using different data rates to transmit the frame data, the EMI peak can be effectively reduced.

It is noted that FIG. 2 is merely for illustrative purposes only, and is not a limitation of the present invention. For example, a number of data rates can be determined according to the designer's consideration, that is the timing controller 110 may use two, four or five different data rates to transmit frame data; FIG. 2 shows that the image data of any two adjacent frames is transmitted by using different data rates, respectively, however, in other embodiments, the image data of some adjacent frames can be transmitted by using the same data rate, for example, using the data rate DR1 to transmit the frames F1-F2 and F4-F5, and using the data rate DR2 to transmit the frames F3 and F6; and in other embodiments, the data rates are not periodically used to transmit the image data of the frames. These alternative designs shall fall within the scope of the present invention.

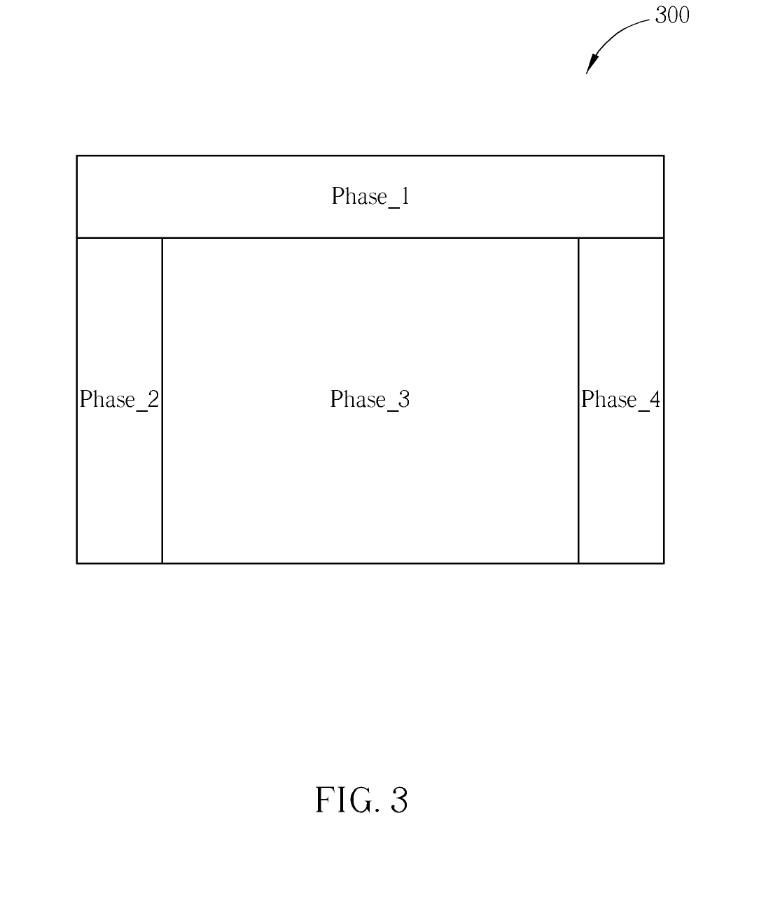

Please refer to FIG. 3, which is a diagram illustrating a format of a frame 300 according to one embodiment of the present invention. Referring to FIG. 3, the frame 300 comprises active image data and inactive data, the active image data is used to be displayed on the active display area 124, that is “Phase_3 ” shown in FIG. 3; and the inactive data is not displayed on the active display area 124, that is the vertical blanking interval (VBI) data, that is “Phase_1” shown in FIG. 3, and the horizontal blanking interval (HBI) data, that is “Phase_2” and “Phase_4” shown in FIG. 3. In this embodiment, the timing controller 110 switches the data rate when preparing to transmit the VBI data to the source drivers 122_1-122_N. In detail, when preparing to transmit the VBI data of the frame 300 to the source drivers, a microprocessor (MCU) built in the timing controller 110 executes a firmware code to switch an oscillator frequency offset to switch the data rate used to transmit the image data of the frame 300.

In addition, in this embodiment, for each frame to be transmitted to the source drivers 122_1-122_N, data amount of the image data of the frame is adjusted by referring to the data rate that is used to transmit the frame, especially for any two frames, the frame to be transmitted with higher data rate has greater data amount. In detail, for each frame, data amount of the inactive data, such as the VBI data and/or the HBI data, of the frame is increased or decreased by referring to the data rate that is used to transmit the image data of the frame.

Taking FIG. 2 as an example, assuming that the image data of each frame inputted into the timing controller 110 has a frame size 2040*1100, the timing controller 110 will add four lines of VBI data to the first frame F1, that is the first frame F1 has the frame size 2044*1100, and uses the data rate DR1 to transmit the first frame F1; then the timing controller 110 will add two lines of VBI data to the second frame F2, that is the second frame F2 has the frame size 2042*1100, and uses the data rate DR2 to transmit the second frame F2; then the timing controller 110 does not adjust the data amount of the third frame F3, that is the third frame F3 has the frame size 2040*1100, and uses the data rate DR3 to transmit the third frame F3 . . . and so one.

For another example, assuming that the image data of each frame inputted into the timing controller 110 has a frame size 2040*1100, the timing controller 110 may increase HBI data to make the first frame F1 have the frame size 2040*1102, and uses the data rate DR1 to transmit the first frame F1; then the timing controller 110 may not adjust the second frame F2, that is the second frame F2 has the frame size 2040*1100, and uses the data rate DR2 to transmit the second frame F2; then the timing controller 110 decrease HBI data to make the third frame F3 has the frame size 2040*1098, and uses the data rate DR3 to transmit the third frame F3 . . . and so one.

By switching the data rate of when preparing to transmit the VBI data, and adjusting data amount of the VBI data of the frame, the active display area 124 will not have flash points.

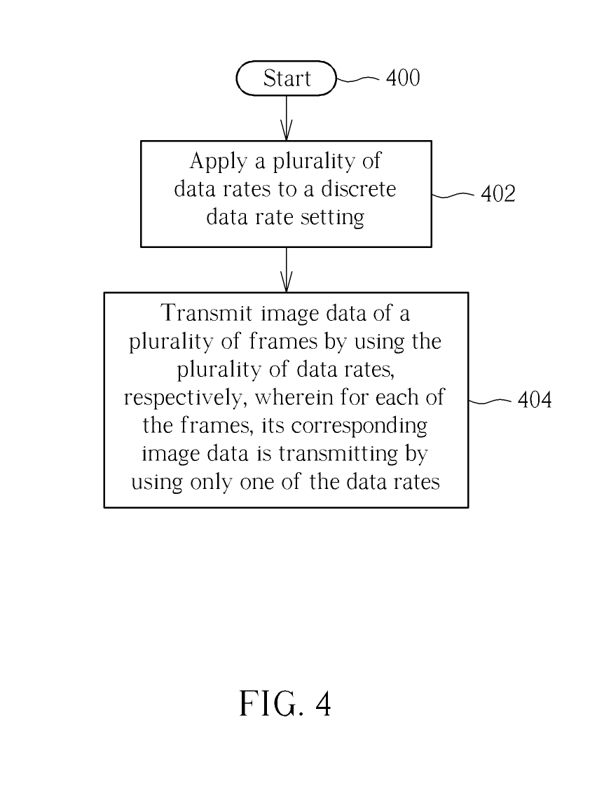

Please refer FIG. 1-FIG. 4 together, FIG. 4 is a flowchart of a method for transmitting data from a timing controller to a source driver according to one embodiment of the present invention. Referring to FIG. 4, the flow is as follows:

Step 400: the flow starts.

Step 402: apply a plurality of data rates to a discrete data rate setting.

Step 404: transmit image data of a plurality of frames by using the plurality of data rates, respectively, wherein for each of the frames, its corresponding image data is transmitting by using only one of the data rates.

Briefly summarized, in the present invention, the timing controller has a discrete data rate setting, and the timing controller transmits image data of a plurality of frames by using the plurality of data rates, respectively. By using the method for transmitting data from a timing controller to a source driver and associated timing controller and display system of the present invention, the EMI peak can be reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for transmitting data from a timing controller to a source driver, comprising:
applying a plurality of data rates to a discrete data rate setting; and
transmitting image data of a plurality of frames by using the plurality of data rates, respectively;
wherein for each of the frames, its corresponding image data is transmitting by using only one of the data rates.

2. The method of claim 1, wherein the image data of any two adjacent frames is transmitted by using different data rates, respectively.

3. The method of claim 1, wherein the step of transmitting the image data of the plurality of frames by using the plurality of data rates, respectively, comprises:
periodically using the plurality of data rates to transmit the image data of the plurality of frames.

4. The method of claim 1, further comprising:
for each frame to be transmitted to the source driver, adjusting data amount of the image data of the frame by referring to the data rate that is used to transmit the image data of the frame.

5. The method of claim 4, wherein each frame comprises active image data and inactive data, the active image data is used to be displayed on an active display area of a display panel, the inactive data is not displayed on the active display area of the display panel, and the step of adjusting the data amount of the image data of the frame by referring to the data rate that is used to transmit the image data of the frame comprises:
for each frame to be transmitted to the source driver, adjusting data amount of the inactive data of the frame by referring to the data rate that is used to transmit the image data of the frame.

6. The method of claim 5, wherein the step of adjusting data amount of the inactive data of the frame by referring to the data rate that is used to transmit the image data of the frame comprises:
for each frame to be transmitted to the source driver, adjusting data amount of vertical blanking interval (VBI) data and/or horizontal blanking interval (HBI) data of the frame by referring to the data rate that is used to transmit the image data of the frame.

7. The method of claim 4, wherein for any two frames, the frame to be transmitted with higher data rate has greater data amount.

8. The method of claim 1, wherein the timing controller is a point-to-point (P2P) timing controller.

9. A timing controller of a display, for applying a plurality of data rates to a discrete data rate setting; and transmitting image data of a plurality of frames by using the plurality of data rates, respectively, wherein for each of the frames, its corresponding image data is transmitting by using only one of the data rates.

10. The timing controller of claim 9, wherein the image data of any two adjacent frames is transmitted by using different data rates, respectively.

11. The timing controller of claim 9, wherein the timing controller periodically uses the plurality of data rates to transmit the image data of the plurality of frames.

12. The timing controller of claim 9, wherein for each frame to be transmitted to the source driver, the timing controller adjusts data amount of the image data of the frame by referring to the data rate that is used to transmit the image data of the frame.

13. The timing controller of claim 12, wherein each frame comprises active image data and inactive data, the active image data is used to be displayed on an active display area of a display panel, the inactive data is not displayed on the active display area of the display panel, and for each frame to be transmitted to the source driver, the timing controller adjusts data amount of the inactive data of the frame by referring to the data rate that is used to transmit the image data of the frame.

14. The timing controller of claim 13, wherein for each frame to be transmitted to the source driver, the timing controller adjusts data amount of vertical blanking interval (VBI) data and/or horizontal blanking interval (HBI) data of the frame by referring to the data rate that is used to transmit the image data of the frame.

15. The timing controller of claim 12, wherein for any two frames, the frame to be transmitted with higher data rate has greater data amount.

16. The timing controller of claim 9, wherein the timing controller is a point-to-point (P2P) timing controller.

17. A display system, comprising:
a timing controller; and
at least one source driver;
wherein the timing controller is arranged for applying a plurality of data rates to a discrete data rate setting, and transmitting image data of a plurality of frames by using the plurality of data rates, respectively, to the source driver; and for each of the frames, its corresponding image data is transmitting by using only one of the data rates.

18. The display system of claim 17, wherein the image data of any two adjacent frames is transmitted by using different data rates, respectively.

19. The display system of claim 17, wherein the timing controller periodically uses the plurality of data rates to transmit the image data of the plurality of frames to the source driver.

20. The display system of claim 17, wherein for each frame to be transmitted to the source driver, the timing controller adjusts data amount of the image data of the frame by referring to the data rate that is used to transmit the image data of the frame.
